(19) United States
(12) Patent Application Publication
(10) Pub. No.: US 2018/0314600 A1
(43) Pub. Date: Nov. 1, 2018

(54) ELECTRONIC DEVICE AND CONTROL METHOD

(71) Applicants: KABUSHIKI KAISHA TOSHIBA, Tokyo (JP); Toshiba Client Solutions CO., LTD, Tokyo (JP)

(72) Inventor: Tomotaka Mori, Tokyo (JP)

(21) Appl. No.: 15/880,412

(22) Filed: Jan. 25, 2018

(30) Foreign Application Priority Data
Apr. 26, 2017 (JP) 2017-087281

(51) Int. Cl. G06F 11/14; G06F 11/16

(52) U.S. Cl. CPC G06F 11/1461; G06F 11/1456; G06F 11/1666

(57) ABSTRACT

According to one embodiment, an electronic device operably connectable to a storage includes a memory and a processor. The processor is electrically connected to the memory, and is configured to acquire failure precursory data concerning the storage, compute a failure risk of the storage, based on the acquired failure precursory data, determine recommended values for two or more backup frequencies of data stored in the storage, a backup data amount, a permissibility of system load for backup, and a backup destination, based on the computed failure risk, and present a setting screen for a backup method in which the determined recommended values are set as initial values respectively for each setting item.

### CROSS-REFERENCE TO RELATED APPLICATION

This application is based upon and claims the benefit of priority from Japanese Patent Application No. 2017-087281, filed Apr. 26, 2017, the entire contents of which are incorporated herein by reference.

### FIELD

Embodiments described herein relate generally to an electronic device and a control method.

### BACKGROUND

Recently, computers have been widespreadly used and measures to securely maintain data stored in storages have become important. More specifically, measures to prevent loss of data (or missing of data) due to storage failure, breakdown or some damage have become important. So as one of the measures backup of the data to different media is often executed.

In a hard disk drive (HDD) which is generally provided as a storage in a personal computer, a failure risk varies depending on a level of aging degradation. Thus, adaptively setting a method for a backup of data against the failure risk is desirable. The method may be defined by combination of a plurality of items such as a backup frequency, backup data amount (type), a permissibility of system load for backup, and a backup destination.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an example of a system configuration of an electronic device of an embodiment.

FIG. 2 is a block diagram showing a plurality of locations which can be selected as data backup destinations by the electronic device of the embodiment.

FIG. 3 is a block diagram showing an example of functional block diagrams of a backup management utility program executed on the electronic device of the embodiment.

FIG. 4 is a table schematically showing contents of a recommended backup method table used in the electronic device of the embodiment.

FIG. 5 is a table showing characteristics of a plurality of candidates (media) that can be selected as the data backup destinations in the electronic device of the embodiment.

FIG. 6 is an illustration showing an example of a backup method setting screen displayed by a backup management utility program in the electronic device of the embodiment.

FIG. 7 is a flowchart showing operating steps related to the settings of the data backup method in the electronic device of the embodiment.

### DETAILED DESCRIPTION

Various embodiments will be described hereinafter with reference to the accompanying drawings.

In general, according to one embodiment, an electronic device operably connectable to a storage includes a memory and a processor. The processor is electrically connected to the memory, and is configured to: acquire failure precursory data concerning the storage; compute a failure risk of the storage, based on the acquired failure precursory data; determine recommended values for two or more backup frequencies of data stored in the storage, a backup data amount, a permissibility of system load for backup, and a backup destination, based on the computed failure risk; and present a setting screen for a backup method in which the determined recommended values are set as initial values respectively for each setting item.

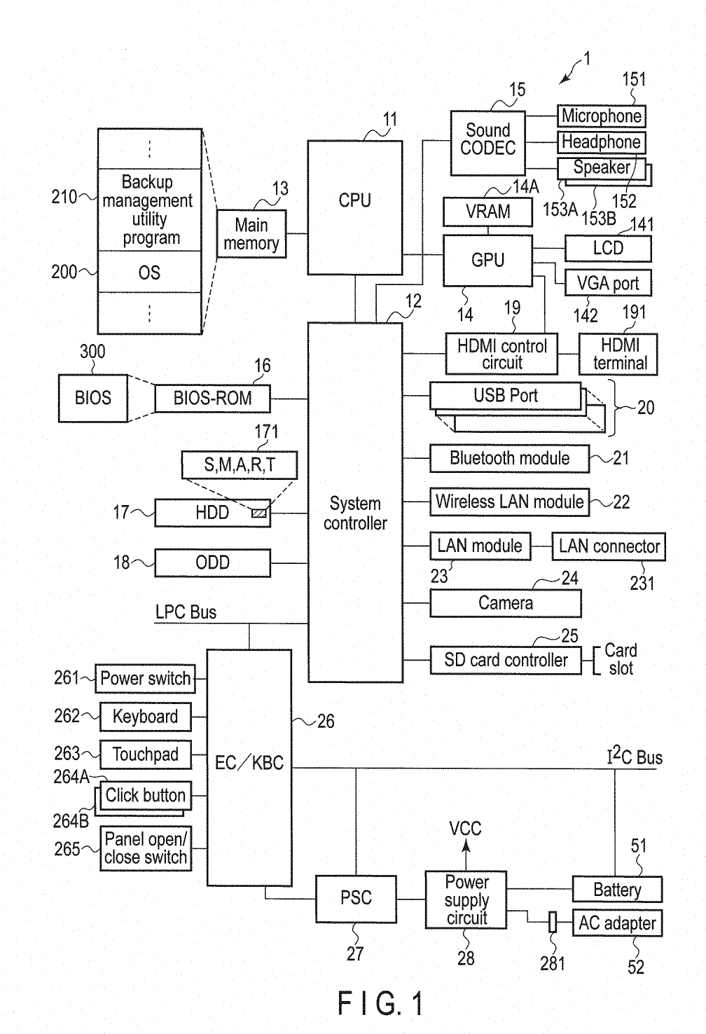

FIG. 1 is a block diagram showing an example of a system configuration of an electronic device of an embodiment. The electronic device is assumed to be implemented as, for example, a personal computer, which is a portable notebook-type personal computer (PC) 1. The electronic device can also be implemented as a computer operating as a file server or the like as well as the personal computer, for example.

As shown in FIG. 1, the PC 1 includes a central processing unit (CPU) 1, a system controller 12, a main memory 13, a graphics processing unit (CPU) 14, a sound codec 15, a basic input/output system (BIOS)-read only memory (ROM) 16, an HDD 17, an optical disc drive (ODD) 18, an HDMI (registered trademark) control circuit 19, and a universal serial bus (USB) port 20. In addition, the PC 1 also includes a Bluetooth (registered trademark) module 21, a wireless local area network (LAN) module 22, a LAN module 23, a camera 24, a secure digital (SD) card controller 25, an embedded controller (EC)/keyboard controller (KBC) 26, a power supply controller (PSC) 27, and a power supply circuit 28.

The CPU 11 is a processor which controls an operation of each component in the PC 1. The CPU 11 loads various types of programs installed in the HDD 17 to the main memory 13 and executes the programs. The CPU 11 operates in conformity with descriptions of the programs and the PC 1 can thereby function as various means. In other words, according to the programs, the PC 1 can implement various functions. The programs include an operating system (OS) 200 and a backup management utility program 210 to he explained later. The CPU 11 can also read a program stored in a storage other than the HDD 17, for example, a magneto-optical disk set in the ODD 18 and execute the program. It is assumed here that the HDD 17 comprises a self-monitoring, analysis and reporting technology (S.M.A.R.T.) function 171. The S.M.A.R.T. function executes self-diagnosis on various inspection items for finding and prediction of failure, and thus the CPU 11 can acquire the S.M.A.R.T. information including data on the various inspection items from the HDD 17.

In addition, the CPU 11 also executes a BIOS 300 stored in a BIOS-ROM 16, which is a nonvolatile memory. The BIOS 300 is a system program to makes the CPU 11 to execute the hardware control.

The CPU 14 is a display controller which controls a liquid crystal display (LCD) 141 built in a lid rotatably attached to a main body. The GPU 14 generates a display signal (LVDS signal) which is to be supplied to the LCD 141 from the display data stored in a video random access memory [RAM] (VRAM) 14A. The CPU 14 can also generate an analog ROB signal and an HDMI video signal from the display data. The analog RGB signal is supplied to an external display device through a VGA port 142. An HDMI output terminal 191 can send an HDMI video signal (uncompressed digital video signal) and a digital audio signal to an external display device by a sole cable. The HDMI control circuit 19 is an interface which transmits the HDMI video signal and the digital audio signal to an external display device through the HDMI output terminal 191.

The system controller 12 is a bridge device which makes connection between the CPU 11 and each of the components. The system controller 12 incorporates a serial ATA (SATA) controller which controls the HDD 17 and the ODD 18. In addition, the system controller 12 comprises a function of transmitting data to and receiving data from a USE device, for example, a USE memory (flash memory) or external HDD, which is connected to the USE port 20 port.

The system controller 12 also comprises a function of transmitting data to and receiving data from an external device via the Bluetooth module 21, the wireless LAN module 22, or the LAN module 23. The system controller 12 also comprises a function of accessing data in an SD card (set to the card slot) via the SD card controller 25. The system controller 12 also comprises a function of executing communications with each of the devices on the low pin count (LPC) bus.

The EC/KBC 26 is connected to the LPC bus. The EC/KBC 26, the PSC 27, and a battery 51 (detachably accommodated in the PC 1) are interconnected via a serial bus such as an I²C bus.

The EC/KBC 26 is a power management controller which executes power management of the PC 1 and is implemented as, for example, a single-chip microcomputer incorporating a keyboard controller which controls a keyboard 262, a touchpad 263, click buttons 264A and 264B, and the like. The EC/KBC 26 comprises a function of powering on/off the PC 1 with an operation of a power switch 261. The power on/off of the PC 1 is controlled. by collaborative operations of the EC/KBC 26 and the PSC 27. The PSC 27 controls the power supply circuit 28 and powers on the PC 1 when receiving an on signal transmitted from the EC/KBC 26. The PSC 27 controls the power supply circuit 28 and powers off the PC 1 when receiving an off signal transmitted from the EC/KBC 26. The EC/KBC 26, the PSC 27, and the power supply circuit 28 operate with the power from the AC/DC adapter 52 connected as the battery 51 or an external power supply, during the period of the PC 1 being off.

The EC/KBC 26 is connected to a panel open/close switch 265 which detects opening/closing of the lid rotatably attached to the main body. The open state of the lid indicates a state in which the lid exists in the position where the upper surface of the main body is exposed, and the closed state of the lid indicates a state in which the lid exists in the position where the upper surface of the main body is covered with the lid. Even when the opening or closing of the lid is detected by the panel open/close switch 265, the EC/KBC 26 can power on/off the PC 1.

The power supply circuit 28 generates the power (operation power) which should be supplied to each of the components with the power from the battery 51 or the AC/DC adapter 52.

Next, the backup management utility program 210 installed in the PC 1 having the above configuration will be explained. The backup management utility program 210 is a program for backing up the data (which may include a program) stored in the HDD 17. More specifically, the backup management utility program 210 is a program for making the CPU 11 to execute backup processing of the data stored in the HDD 17.

In the HDD 17, a failure risk varies depending on the level of aging deterioration or the like. For example, a low backup frequency may be permitted if it is immediately after starting use of the HDD 17 which has a low failure risk. On the other hand, a high backup frequency may be desirable if it is after long time period of use of the HDD 17 which has a high failure risk. In addition, in the case of the failure risk being low, only data itself can be set as a backup target so that the backup data volume is suppressed to a small level. In the case of the failure risk being high, a program adding to the data may be set as the backup target. Thus, the backup data volume may be adaptively managed according to stages of the risk, for example.

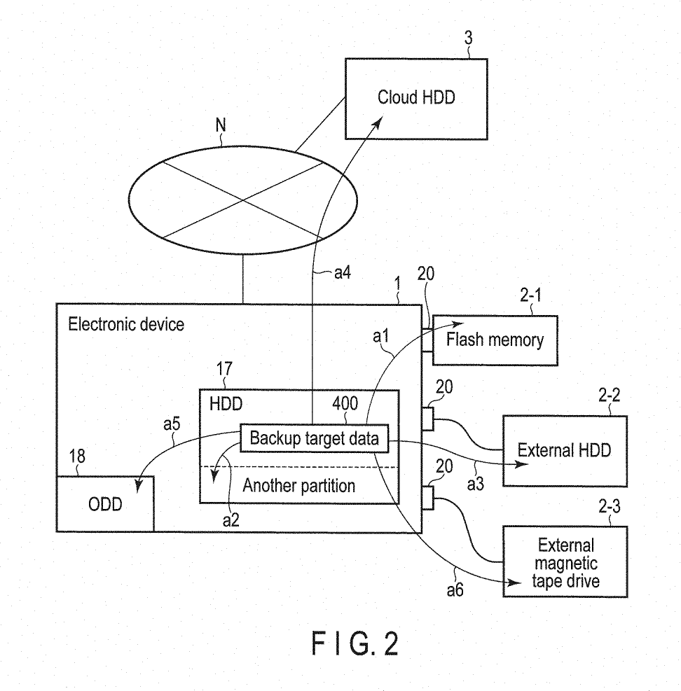

As explained above, the PC 1 comprises the USB port 20, various communication modules such as the Bluetooth module 21, the wireless local area network (LAN) module 22, and the LAN module 23, and further comprises the ODD 18. The PC 1 can therefore select the backup destination of the data stored in the HDD 17 from a plurality of candidates (a1-a6) as shown in, for example, FIG. 2. More specifically, the PC 1 can select a USB memory (flash memory) 2-1 connected to the USB port 20, which is represented by arrow a1, another partition (different from a partition an which backup target data is stored) of the HDD 17, which is represented by arrow a2, an external HDD 2-2 connected to the USB port 20, which is represented by arrow a3, a cloud HDD 3 on, for example, the Internet N, which is represented by arrow a4, a magneto-optical disk set to ODD 18, which is represented by arrow a5, a magnetic tape set to an external magnetic tape drive 2-3 connected to the USB port 20, which is represented by arrow a6, and the like. Since these have merits and demerits from the viewpoint of applicability as the backup destination, the selection is desirably executed in accordance with the failure risk of the HDD 17. The partition in which the backup target data is stored is, for example, that where the OS 200 is installed, but is not limited to this. Moreover, it is assumed here that the PC 1 comprises the ODD 18, but backup of the data to the magneto-optical disk can also be executed by, for example, an external ODD connected to the USB port 20.

Furthermore, permissibility of the system load for backup is also desirably set according to the failure risk of the HDD 17. More specifically, desirably, an assignment time per unit time of the CPU 11 is suppressed to a small level when the failure risk is low, and the permissibility of the system load for backup is managed, for example, assignment time per unit time of the CPU 11 increased when the failure risk is high.

However, it is difficult for the user to adaptively set a backup method defined by a combination of the above items according to the failure risk of the HDD 17. Thus, the PC 1 of the present embodiment provides a user interface for supporting the user to be able to adaptively set the backup method by the backup management utility program 210, and this matter will be explained hereinafter in detail.

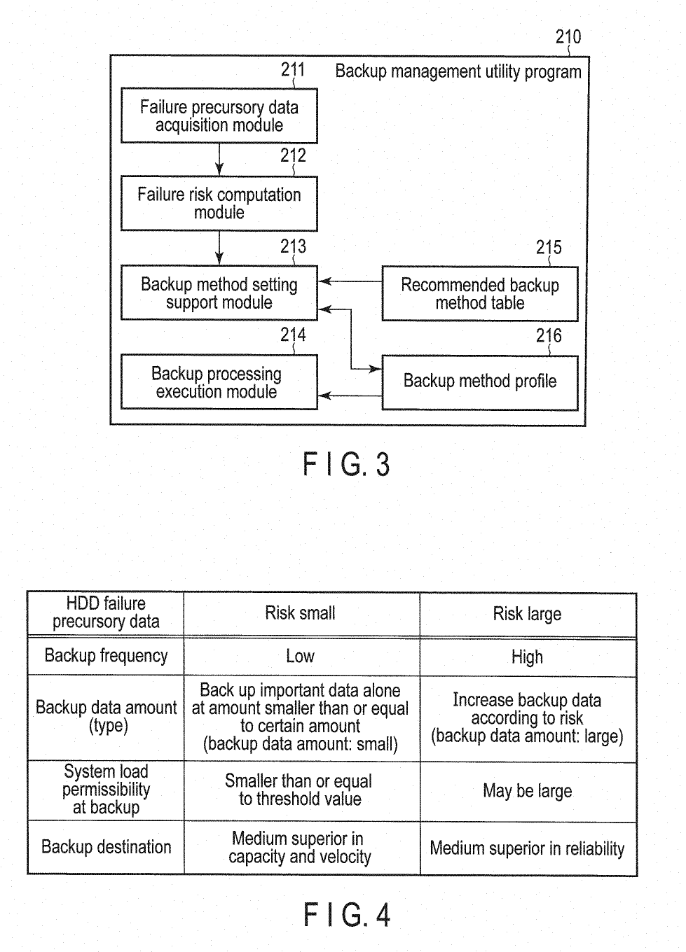

FIG. 3 shows an example of functional blocks of the backup management utility program 210. As shown in FIG. 3, the backup management utility program 210 comprises a failure precursory data acquisition module 211, a failure risk computation module 212, a backup method setting support module 213, and a backup processing execution module 214. In addition, the backup management utility program 210 comprises a recommended backup method table 215 and a backup method profile 216. The recommended backup method table 215 and the backup method profile 216 are data files which are constructed on the storage area of the HDD 17 and accessed by the CPU 11 via the main memory 13. FIG. 1 shows only one CPU 11 as the processor which executes the backup management utility program 210, but the functions executed by the PC 1 with the respective modules of the backup management utility program 210 shown in FIG. 3 may be executed by a plurality of processors. Each function is not limited to that executed by means of a program using a processor but, may be implemented by, for example, an exclusive electric circuit.

The failure precursory data acquisition module 211 is a module for making the CPU 11 to execute processing of acquiring the above-explained S.M.A.R.T. information (failure precursory data) from the HDD 17. The failure risk computation module 212 is a module for making the CPU 11 to execute processing of computing the failure risk of the HDD 17, based on failure precursory data. A manner of computing the failure risk of the HDD 17 based on the S.M.A.R.T. information is not limited to a specific manner but various known manners can be applied as the manner. Since the HDD 17 is assumed to comprise the S.M.A.R.T. function, the S.M.A.R.T. information is acquired as the failure precursory data (to compute the failure risk of the HDD 17), but the failure precursory data is not limited to the S.M.A.R.T. information. If the failure risk can be computed, vendor's own statistic values and the like may be acquired as the failure precursory data. The failure precursory data may not be necessarily acquired directly from the HDD 17. For example, if a program which monitors each component of the PC 1 containing the HDD 17 exists, information concerning the HDD 17 which is collected by the program may be acquired as the failure precursory data.

The backup method setting support module 213 is a module for making the CPU 11 to execute processing of displaying the backup method setting screen including the above-mentioned items on the LCD 141. In addition, when the backup method setting screen is displayed, the backup method setting support module 213 determines a recommended value of each item, based on the failure risk of HDD 17, and makes the CPU 11 to execute processing of showing the recommended value as an initial value on the backup method setting screen. The recommended backup method table 215 is a table which holds a correspondence between the failure risk of the HDD 17 and the backup method which should be recommended, and the CPU 11 operating in conformity with descriptions of the backup method setting support module 213 determines a recommended value for each item with reference to the recommended backup method table 215.

FIG. 4 is a table schematically showing contents of the recommended backup method table 215.

As shown in FIG. 4, the recommended backup method table 215 holds data indicating that a low value should be recommended as a backup frequency if the failure risk computed from the failure precursory data is low, and that a high value should be recommended if the failure risk is high.

in addition, the recommended. backup method table 215 holds data indicating that a small value should be recommended as the backup data amount such that backup of only important data should be executed at an amount smaller than or equal to a certain amount, if the failure risk is low, and that a large value should be recommended as the backup data amount so as to increase the backup target according to the risk if the failure risk is high. Various known manners can be applied in order to determine the backup target according to the failure risk. For example, ranking may be executed for every type of data and the type of data to be used as the backup target may be increased in order of ranking as the failure risk increases, or ranking may be executed for each element of data irrespective of the data type and the type of data to be used as the backup target may be increased in order of ranking as the failure risk increases. Alternatively, only the data file may be used as the backup target if the failure risk is below a threshold value, and the program file may be added to the backup target if the failure risk exceeds a threshold value.

Moreover, the recommended backup method table 215 holds date indicating that a value smaller than or equal to a threshold value should be recommended as a system load permissibility at the time of backup, if the failure risk is low, and that a large value exceeding the threshold value should be recommended if the failure risk is high.

Moreover, the recommended backup method table 215 holds data indicating that a medium superior in capacity and velocity should be recommended as the backup destination, if the failure risk is low, and that a medium superior in reliability should be recommended if the failure risk is high.

It does not particularly matter how the recommended backup method table 215 converts the above contents into data and holds the data. In other words, if the above contents are shown, it is not a problem how the recommended backup method table 215 is constituted.

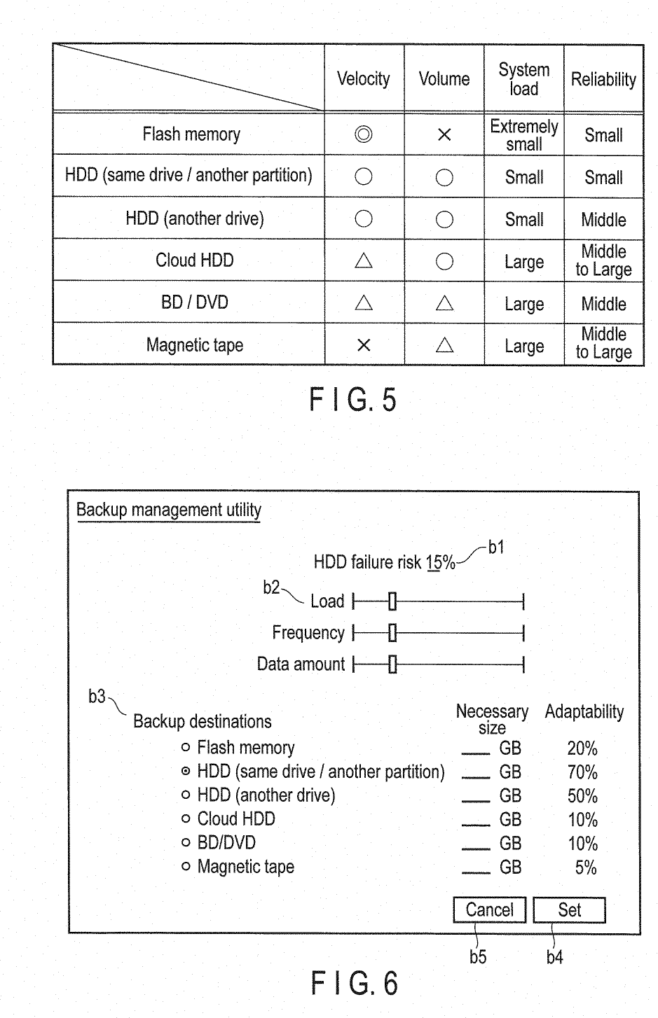

FIG. 5 is a table showing characteristics of each a plurality of candidates (media) that can be selected as a data backup destination.

For example, a flash memory is superior in its velocity and system load although inferior in its capacity and reliability. A HDD (same drive/another partition) is superior in velocity, capacity, and system load although inferior in reliability. A HDD (another drive) is superior in its reliability, as compared with the HDD (same drive/another partition). A cloud HDD is superior in its capacity and reliability although inferior in its velocity and system load. A magneto-optical disk (BD/DVD) is superior in its reliability although inferior in its velocity, capacity, and system load. Moreover, the magnetic tape is further inferior in its velocity to the magneto-optical disk.

When the recommended backup method table 215 shown in FIG. 4 is referred to based on the above characteristics of the respective media, applicability of the flash memory or the HDD is considered high as the media of backup destination if the failure risk of the HDD 17 is low, while applicability of the cloud HDD, the magneto-optical disk, or the magnetic tape is considered high if the failure risk is high.

FIG. 6 is an illustration showing an example of the backup method setting screen which the CPU 11 operating in conformity with descriptions of the backup method setting support module 213 displays on the LCD 141. This setting screen is, for example, a screen which can be displayed by operating a menu on a basic screen of the backup management utility program 210. The CPU 11 can display the screen on the LCD 141 by writing the display data for screen to the VRAM 14A via the GPU 14. In addition, the CPU 11 can receive the data input to input fields on the screen by using the keyboard 262 and the click buttons 264A and 264, via the EC/KBC 26 and the system controller 12.

As shown in FIG. 6, a field (b1) indicating the failure risk of the HDD 17 is first provided on the backup method setting screen. The failure risk of the HDD 17 computed from the latest failure precursory data is represented in the field b1. The failure risk of the HDD 17 represented in the field b1 is therefore varied to a1 larger value as the period of use of the HDD 17 becomes long.

In addition, a field (b2) in which the user can arbitrarily set the system load permissibility, the backup frequency, and the backup data amount at the backup time is secondarily provided on the backup method setting screen. For example, if the user wishes to raise the system load permissibility at the backup time, the user moves a slider to the right side. Use of a slider in the setting is a mere example and various manners such as urging entry of a numerical value can be adopted.

Then, when the backup method setting screen is displayed, the backup method setting support module 213 or, more specifically, the CPU 11 operating in conformity with descriptions of the backup method setting support module 213 determines recommended values of the system load permissibility, the backup frequency, and the backup data amount at the backup time, based on the failure risk of the HDD 17, and sets each of sliders in the field b2 so as to represent the recommended values. It does not particularly matter how the recommended values of the respective items are determined.

In addition, a field (b3) in which the user can arbitrarily set the backup destination is thirdly provided on the backup method setting screen. A plurality of media are presented as options in the field b3, and one of them can be selected as an exclusion selection target with a radio button. The selection using the radio button is also a mere example and, for example, various manners such as displaying a list of a plurality of media in a pull-down menu form and urging to select one of them can be adopted.

The failure risk computation module 212 includes a description for making the CPU 11 to execute the processing of computing the failure risk of the HDD 17 and a description for making the CPU 11 to execute the processing of computing the adaptability of each medium as a backup destination, based on the failure risk of the HDD 17. Then, when the backup method setting screen is displayed, the backup method setting support module 213 or, more specifically, the CPU 11 operating in conformity with the descriptions of the backup method setting support module 213 presents the adaptability of each medium as the backup destination computed based on the failure risk of the HDD 17, in the field b3, and sets the radio button such that the media of the highest adaptability is set in a selected status. In other words, the recommended value of the backup destination is presented to the user in addition to the system load permissibility, the backup frequency, and the backup data amount at the backup. It does not particularly matter how the adaptability of each medium is computed.

Thus, when the backup method setting screen is displayed, the PC 1 of the embodiment presents a plurality of items such as the system load permissibility, the backup frequency, the backup data amount, and the backup destination at the backup, by initially setting the items with the recommended values determined in accordance with the failure risk of the HDD 17, and supports adaptive setting of the backup method according to the failure risk.

Furthermore, for example, text data and the like describing the reason for recommendation of the recommended backup method may be stored in the backup method table 215 and the reason for recommendation may be presented on the backup method setting screen.

In addition, if operations to move the sliders of the field b2 are executed, the backup method setting support module 213 or, more specifically, the CPU 11 operating in conformity with the descriptions of the backup method setting support module 213 may vary the recommended value of the backup destination presented in the field b3 in association with these operations. For example, if the backup data amount recommended based on the failure risk is low but the user remarkably increases the backup data amount, the medium may be changed to a medium suitable to back up a large amount of data.

If the user wishes to confirm the contents set on the backup method setting screen, the user operates a set button b4. If this operation is executed, the backup method setting support module 213 or, more specifically, the CPU 11 operating in conformity with the descriptions of the backup method setting support module 213 records the contents in the backup method profile 216. If the set button. bra is operated, the display on the LCD 141 returns to, for example, the basic screen of the backup management utility program 210.

In addition, a cancel button b5 for canceling the contents set on the backup method setting screen is also arranged on the backup method setting screen. If the cancel button b5 is operated, the display on LCD 141 returns to, for example, the basic screen of the backup management utility program 210 without recording the contents set on the backup method setting screen in the backup method profile 216.

FIG. 6 shows the example of presenting the recommended values of the system load permissibility, the backup frequency, the backup data amount, and the backup destination at the backup as determined based on the failure risk of the HDD 17 but, since the existing setting contents are recorded in the backup method profile 216, the backup method setting support module 213 or, more specifically, the CPU 11 operating in conformity with the descriptions of the backup method setting support module 213 may present the existing setting contents together.

The backup processing execution module 214 is a module for making the CPU 11 to execute the processing of backing up the data, based on the backup method profile 216 in which the contents of the backup method set in the above-mentioned manner are recorded. The CPU 11 operating in conformity with the descriptions of the backup processing execution module 214 can recognize, for example, the type of the USE device connected to the USE port 20, based on the class information included in the descriptor acquired from the USE device. For example, another HDD (external HDD 2-2 of FIG. 2) may be selected as a backup destination and the external HDD 2-2 may not be connected to the USE port 20 in the timing of executing the backup processing. In this case, for example, the CPU 11 operating in conformity with the descriptions of the backup processing execution module 214 may display a warning message on the LCD 141 or may postpone backup to the timing. The manner of responding to such a case may be arbitrary. For example, the manner of responding to a case of selecting the cloud HDD as the backup destination and being unable to communicate with the cloud HDD in the timing of executing the backup processing may be also arbitrary.

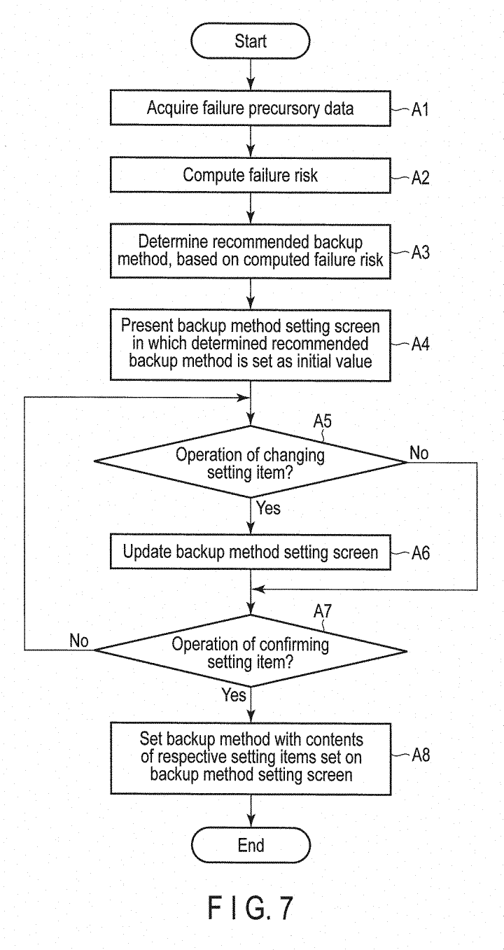

FIG. 7 is a flowchart showing operation steps of settings for the data backup method of the PC 1.

First, the CPU 11 acquires, for example, the failure precursory data which is S.M.A.R.T. information or the like from the HDD 17 in conformity with the descriptions of the failure precursory data acquisition module 211 (step A1). Next, the CPU 11 computes the failure risk of the HDD 17, based on the failure precursory data, in conformity with the descriptions of the failure risk computation module 212 (step A2).

The CPU 11 determines the recommended backup method, based on the computed failure risk, in conformity with the descriptions of the backup method setting support module 213 (step A3), and displays the backup method setting screen in which the determined recommended backup method is set as the initial value, on the LCD 141 (step A4).

If the operation of changing the setting item is executed on the backup method setting screen (YES in step A5), the CPU 11 updates the backup method setting screen displayed on the LCD 141 in conformity with the descriptions of the backup method setting support module 213 (step A6). More specifically, a recommended backup method adaptable to the user setting is newly determined, and the determined recommended backup method is shown on the backup method setting screen.

If the operation of confirming the setting item is executed on the backup method setting screen (YES in step A7), the CPU 11 sets the backup method with the contents of the respective setting items set on the backup method setting screen, in conformity with the descriptions of the backup method setting support module 213 (step A8). More specifically, the CPU 11 records the contents of the respective setting items set on the backup method setting screen in the backup method profile 216.

As described above, an adaptive setting of the backup method according to the failure risk can be supported by the PC 1 of the embodiments.

In the above explanations, if the user displays the backup method setting screen to execute the setting of the backup method, the recommended backup method is presented on the backup method setting screen. In addition, the backup management utility program 210 may be configured to urge the CPU 11 to periodically execute acquisition of the failure precursory data, computation of the failure risk, and determination of the recommended backup method and to urge the CPU 11 to execute display of a message to review the settings of the backup method, for example, in the timing in which the contents of the backup method to be recommended such as the backup destination are different from the previous contents.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device operably connectable to a storage, comprising:
a memory; and
a processor electrically connected to the memory, and configured to
acquire failure precursory data concerning the storage,
compute a failure risk of the storage, based on the acquired failure precursory data,
determine recommended values for two or more backup frequencies of data stored in the storage, a backup data amount, a permissibility of system load for backup, and a backup destination, based on the computed failure risk, and
present a setting screen for a backup method in which the determined recommended values are set as initial values respectively for each setting item.

2. The electronic device of claim 1, wherein the processor is configured to present the failure risk on the setting screen for the backup method.

3. The electronic device of claim 1, wherein the processor is configured to
compute adaptability of each candidate of the backup destination to the failure risk, and
present the adaptability on the setting screen for the backup method.

4. The electronic device of claim 1, wherein the processor is configured to update the recommended values of the backup destination represented on the setting screen for the backup method, in accordance with variation in the backup frequencies, the backup data amount, and the permissibility of system load for the backup on the setting screen for the backup method.

5. The electronic device of claim 1, further comprising a connector for connection with an external device,
wherein the setting screen for the backup method comprises options for designating a type of the external device connected via the connector as the backup destination.

6. The electronic device of claim 5, wherein one of the options comprises an option for designating a flash memory as the type of the external device.

7. The electronic device of claim 5, wherein one of the options comprises an option for designating a magnetic tape device capable of writing data to a magnetic tape as the type of the external device.

8. The electronic device of claim 1, further comprising a communication device configured to communicate with an external device,
wherein the setting screen for the backup method comprises an option for designating an external device capable of data transmission and reception using the communication device as the backup destination.

9. The electronic device of claim 1, wherein:
a memory area of the storage is dividable into a plurality of sections; and
the setting screen for the backup method comprises an option for designating a different section as the backup destination.

10. The electronic device of claim 1, further comprising a magneto-optical disk drive capable of writing data to a magneto-optical disk,
wherein the setting screen for the backup method comprises an option for designating the magneto-optical disk drive as the backup destination.

11. The electronic device of claim 5, wherein:
the storage comprises a self-monitoring, analysis and reporting technology (S.M.A.R.T.) function; and
the processor is configured to acquire the S.M.A.R.T. information from the storage as the failure precursory data.

12. A control method executed by an electronic device operably connectable to a storage, the method comprising:
acquiring failure precursory data concerning the storage;
computing a failure risk of the storage, based on the acquired failure precursory data;
determining recommended values for two or more backup frequencies of data stored in the storage, a backup data amount, a per of system load for backup or a backup destination, based on the computed failure risk; and
presenting a setting screen for a backup method in which the determined recommended values are set as initial values respectively for each setting item.
